(19) United States
(12) Patent Application Publication
(10) Pub. No.: US 2005/0210283 A1
(43) Pub. Date: Sep. 22, 2005

(54) Wireless key system

(75) Inventor: Shinta Kato, Tokyo (JP)

Correspondence Address: NIXON PEABODY, LLP, 401 9TH STREET, NW, SUITE 900, WASHINGTON, DC, 20004-2128, US

(73) Assignee: Oki Electric industry Co., Ltd., Tokyo (JP)

(21) Appl. No.: 11/043,996

(22) Filed: Jan. 28, 2005

(30) Foreign Application Priority Data
Feb. 27, 2004 (JP) 2004-054412

(51) Int. Cl. H04B 1/00

(52) U.S. Cl. 713/200; 340/5.23

(57) ABSTRACT

A wireless key system employs short-range wireless communication to transmit key information from a key device to a lock device. The lock device then authenticates the wireless communication link between the lock device and key device, and unlocks a door or other structure if authentication succeeds. The key information used for authentication may include both a unique address and a shared code. Besides unlocking a door, the system may perform other functions, such as monitoring room occupancy, switching power on and off, and taking safety measures when the key device is moved out of communication range with the lock device.

### BACKGROUND OF THE INVENTION

1. Field of the Invention

The present invention relates to a key system that unlocks a lock by wireless communication, more particularly by short-range wireless communication.

2. Description of the Related Art

Doors and the like are conventionally locked and unlocked by use of a manually inserted metal key or card key. A metal key is inserted into a metal cylinder that can be turned if the key has a particular shape. In a hotel employing metal keys, the guest receives the key at the front desk, and a clerk at the front desk can tell which rooms are occupied by noting which keys have been taken. In a hotel that issues card keys, the hotel guest inserts the card key into a slot to open the door of his or her room, and may have to insert the card into a device installed in the room to close a circuit breaker that supplies electricity to the room.

A well-known problem with metal keys is that they can be copied by a straightforward metalworking process. Another problem with metal keys is that if the key is lost, both the key and the lock have to be replaced. In a hotel, a further problem is that the clerk cannot be sure that a room is occupied, because guests sometimes keep their keys with them when outside the hotel. This last problem is solved by card key systems in which the card key also turns on the electricity in the room, but the need to insert the card key in a special device in the room is inconvenient for the hotel guest.

Another problem with conventional key systems is that if the door automatically locks when shut, the key may become locked in the room if inadvertently left therein. A further problem with house keys is that when leaving the house unoccupied; a person must take numerous safety precautions, such as shutting other doors and windows and turning off unnecessary gas and electrical appliances.

Wireless key systems are also known. Two examples are described in Japanese Unexamined Patent Application Publication Nos. 2001-193324 and 2002-339654.

### SUMMARY OF THE INVENTION

An object of the present invention is to provide a convenient key system for locking and unlocking a structure.

Another object is to provide a secure key system.

The invented key system employs short-range wireless communication. The system includes a lock device that locks and unlocks a structure such as a door of a house, room, or automobile, and a key device that transmits key information to the lock device by short-range wireless communication. The lock device uses the key information received from the key device to authenticate a wireless communication link with the key device, and unlocks the structure if the authentication succeeds.

The lock device and key device preferably have unique information such as unique addresses assigned to their short-range wireless communication means. The key device sends its unique information to the lock device as at least part of the key information that the lock device uses to authenticate the wireless communication link. The lock device may transmit its unique information to the key device.

The lock device and key device may also store a shared code, which forms another part of the key information used to authenticate the wireless communication link, and may have input means for initial input and update of the unique information and the shared code.

Besides locking and unlocking the structure, the lock device may provide information to a further device that, for example, monitors room occupancy, switches power of electrical appliances on and off, shuts off gas or water supplies, or takes other safety measures.

The invented key system is convenient because, in addition to unlocking doors and the like, it can perform various other functions in a completely automatic manner, without requiring the user to insert the key in a lock or other receptacle.

The system is secure because the unlocking operation must be preceded by successful authentication. In particular, the use of both unique information and a shared code provides a high level of security.

### BRIEF DESCRIPTION OF THE DRAWINGS

In the attached drawings:

FIG. 1 illustrates the configuration of a key system according to the present invention;

FIG. 2 is a block diagram illustrating the structure of the lock device in FIG. 1;

FIG. 3 is a block diagram illustrating the structure of the key device in FIG. 1;

FIG. 4 is a sequence diagram illustrating the operation of the key system in FIG. 1;

FIG. 5 illustrates the configuration of a key system according to another embodiment of the invention;

FIG. 6 is a block diagram illustrating the structure of the key device in FIG. 5;

FIG. 7 is a sequence diagram illustrating the operation of the key system in FIG. 5;

FIG. 8 illustrates another key system, based on the key system in FIG. 1;

FIG. 9 is a sequence diagram illustrating the operation of the key system in FIG. 8;

FIG. 10 illustrates the configuration of another key system based on the key system in FIG. 1; and

FIG. 11 is a block diagram illustrating the structure of the co-operating device in the key system in FIG. 10.

### DETAILED DESCRIPTION OF THE INVENTION

Embodiments of the invention will now be described with reference to the attached drawings, in which like elements are indicated by like reference characters.

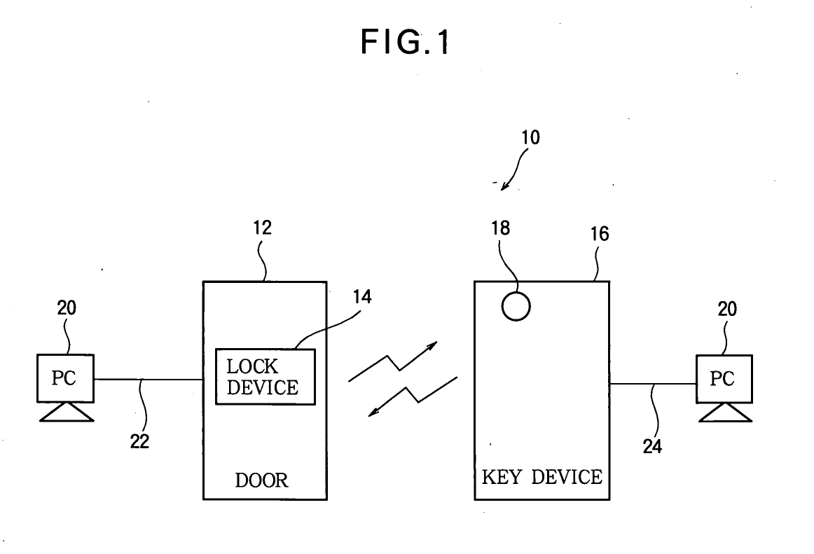

Referring to FIG. 1, a first embodiment of the invention is a key system 10 for locking and unlocking a door 12 of a room, house, office, or other such structure. The door may be a hinged door, sliding door, gate, shutter, or any other device that openably and closably separates the space inside the structure from the space outside the structure. Installed in the door 12 is a lock device 14 that locks and unlocks the door 12 in cooperation with a paired key device 16. The door 12 is immobilized in the locked state, and is capable of being moved in the unlocked state.

In the key system 10, the lock device 14 and key device 16 exchange key information by short-range wireless communication, the lock device 14 authenticates the key information received from the key device 16, and the door 12 is unlocked if the authentication succeeds. The key device 16 in this embodiment has a page button 18 for initiating transmission of the key information, and functions uniquely for transmitting the key information when the page button 18 is pressed. Communication technology conforming to the Bluetooth (trade mark) specification can be advantageously applied as the short-range wireless communication technology in the present embodiment. The use of Bluetooth technology will be assumed in the following description.

In the key system 10, the lock device 14 and key device 16 are connected through cables 22 and 24 to respective setup devices 20 (personal computers, denoted PC in the drawing). The setup devices 20 are used for initial setting of the key information in the lock device 14 and key device 16. In the initial setting process, each setup device 20 executes, for example, an interactive program that presets a Bluetooth device address (BD_ADDR) and a personal identity number (PIN) code. The Bluetooth device address of the lock device 14 is preset in the key device 16; the Bluetooth device address of the key device 16 is preset in the lock device 14. The PIN code is common to both the lock device 14 and key device 16. After the initial setting of the key information has been completed, the cables 22 and 24 are disconnected and the lock device 14 and key device 16 operate separately from the setup devices 20.

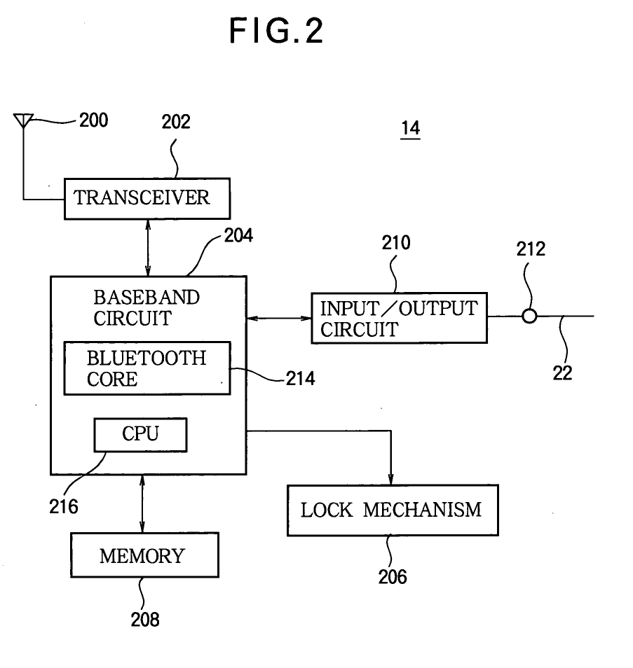

FIG. 2 is an exemplary block diagram illustrating the internal structure of the lock device 14. In this example, the lock device 14 comprises an antenna 200, a transceiver 202, and a baseband circuit 204. The antenna 200 transmits and receives radio signals. The transceiver 202 receives a 2.4-GHz band signal from the antenna 200 and outputs a transmit signal to the antenna 200. The baseband circuit 204, which is connected to the transceiver 202, processes the transmitted and received signals. The baseband circuit 204 is also connected to a memory 208, an input/output circuit 210 that inputs and outputs key information and other information, and a lock mechanism 206 that unlocks and locks the door 12.

The transceiver 202 comprises transmitting and receiving circuits. The transmitting circuit converts a baseband transmit signal output from the baseband circuit 204 to a radio signal by using a frequency hopping spread spectrum transmission scheme and a binary frequency shift keying modulation scheme. The receiving circuit demodulates and despreads a radio signal received from the antenna 200 to obtain a baseband signal. Although the structure of the transmitting and receiving circuits is not shown in the drawings, the receiving circuit includes a radio frequency (RF) circuit, an intermediate frequency (IF) circuit, and a demodulator, while the transmitting circuit includes, for example, a pulse forming circuit, a mixer, and a power amplifier that outputs a transmit signal amplified to about one milliwatt (1 mW) to the antenna 200.

The baseband circuit 204 functions as a baseband processor that converts information to be transmitted to a baseband signal for output to the transceiver 202, and extracts necessary data from a signal received from the transceiver 202. The baseband circuit 204 includes a Bluetooth core 214 that performs transmission control conforming to the Bluetooth specification and a central processing unit (CPU) 216 that manages the control states of the Bluetooth core 214. The CPU 216 also controls the lock mechanism 206 according to the signal transmitted by and received from the paired key device 16.

Although not shown in the drawing, to perform data processing in the baseband layer, the Bluetooth core 214 includes an error detecting encoder, a scrambler circuit that encrypts information to be transmitted, and an error correcting encoder in its transmitting section, and includes a correlator, an error correction circuit, a descrambler circuit, a decryption circuit, and an error detection circuit in its receiving section.

The CPU 216 performs control processing for the baseband circuit 204. The functions of the CPU 216 include assigning transmitting and receiving frequencies and a transmitting power level to the transceiver 202, and passing the payload of a data packet to a higher protocol layer. The CPU 216 also holds in memory the Bluetooth device address as unique information assigned to the Bluetooth module 214. Another function of the CPU 216 is to store information supplied from the input/output circuit 210 in the memory 208 and read out information stored in the memory 208.

Specifically, when an initial setting is performed to start the operation of the key system 10, the CPU 216 receives the Bluetooth device address (BD_ADDR) of the key device 16 through the input/output circuit 210 and stores it in the memory 208. The CPU 216 also receives the PIN code through the input/output circuit 210 and stores it in the memory 208. The same PIN code is set in the key device 16 during the initial setting of the key device 16. The CPU 216 thus prestores the Bluetooth device address, which is unique to the key device 16, and the PIN code, which is common to both devices, as key information. The input/output circuit 210 is an interface circuit that receives key information supplied from the setup device 20, which is connected through the cable 22 to a connector 212, and outputs the key information to the baseband circuit 204. The interface preferably matches a general purpose interface provided in the setup device 20, such as, in the case of serial communication, a universal serial bus (USB) interface, a network interface, or the like.

The CPU 216 controls processing performed in a Page_Scan mode to authenticate a connection with the key device 16 by wireless communication with the key device 16. In general, a Bluetooth device operating in the Page_Scan mode waits to receive a paging signal specifying its own Bluetooth device address. In the present embodiment, the page scan is more restricted: the lock device 12 waits to receive a paging signal from the key device 16 having the Bluetooth device address that the CPU 216 stored during the initial setting operation, and then proceeds to authenticate a connection with the key device 16 by using the key information transmitted from the key device 16. Authentication succeeds if the Bluetooth device address (BD_ADDR) in the key information transmitted from the key device 16 matches the Bluetooth device address already stored in the memory 208 and the PIN code transmitted from the key device 16 matches the PIN code shared and stored during the initial setting. When authentication succeeds, the CPU 216 performs a pairing process with the key device 16, generates an unlock signal for unlocking the door, and sends the unlock signal to the lock mechanism 206 as an output from the baseband circuit 204.

The memory 208 has a memory region for storing the Bluetooth device address of the unique key device 16 that can pair with the lock device 14, and another memory region for storing the PIN code shared by the lock device 14 and key device 16. This information is used for authenticating the key device 16. The memory 208 also stores information describing control procedures to be taken depending on whether authentication of a connection succeeds or fails. In the present embodiment, the program stored in the memory 208 describes the procedure for generating and outputting the unlock signal as a trigger that unlocks the door 12 when authentication succeeds. A rewritable nonvolatile memory such as an electrically erasable and programmable read-only memory (EEPROM) or flash memory can be advantageously used for the memory 208.

The lock mechanism 206 installed in the door 12 is a mechanical device that locks the door 12. When the lock mechanism 206 receives an unlock signal from the baseband circuit 204, it releases the lock so that the door 12 can be opened and closed. In the present embodiment, in response to the unlock signal, the door lock is released for several seconds, for example; the length of time is selectable, depending on a setting. The lock mechanism 206 also has an auto-lock function that automatically locks the door 12 a predetermined number of seconds after it has been opened and closed.

The lock device 14 has a reset function for resetting (that is, updating) the key information after it has been set and stored. Specifically, the lock device 14 can be reconnected to the setup device 20 through the connector 212 and cable 22, and can store the Bluetooth device address of another key device 16, which can then be used in place of the previous key device. The PIN code can also be reset to a different value from the previously used code. The previous Bluetooth device address and PIN code are both made unusable by, for example, deleting them from the memory 208. Therefore, if the key device 16 is lost, security can be maintained without replacing the lock device 14 by resetting the key information so that the door cannot be unlocked by a third party who happens to find the lost key.

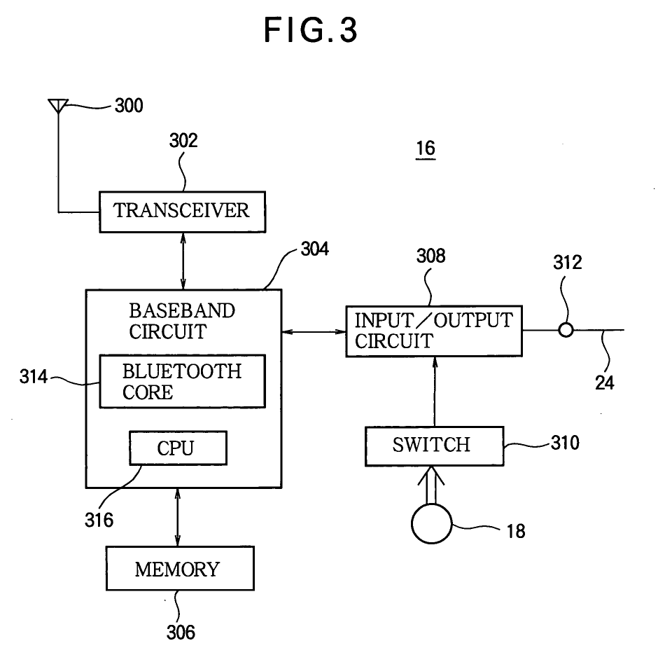

FIG. 3 is an exemplary block diagram illustrating the internal structure of the key device 16. As shown in FIG. 3, the key device 16 is a short-range wireless communication device comprising an antenna 300, a transceiver 302, a baseband circuit 304, a memory 306, and an input/output circuit 308. These constituent elements may be substantially identical to the antenna 200, transceiver 202, baseband circuit 204, memory 208, and input/output circuit 210 in the lock device 14, so repeated descriptions will be omitted. The key device 16 further includes the page button 18 for unlocking the door 12 and a switch 310 that turns on when the page button 18 is depressed, the switch 310 being connected to the input/output circuit 308.

The functions of the central processing unit (CPU) 316 in the baseband circuit 304 of the key device 16 include recognizing the press of the page button 18 when the baseband circuit 304 detects an ‘on’ signal from the switch 310 through the input/output circuit 308. The CPU 316 also begins control of a paging operation (connecting operation) in response to the ‘on’ signal. In the paging operation, the key device 16 transmits key information to the lock device 14, which then authenticates the connection as described above. The Bluetooth core 314 in the baseband circuit 304 may have the same structure as the Bluetooth core 214 in FIG. 2.

When the initial setting is performed, a setup device 20 is connected to a connector 312 of the key device 16 to supply key information to the baseband circuit 304 through the input/output circuit 308. The key information includes the Bluetooth device address (BD_ADDR) of the lock device 14 and the shared PIN code described above. The CPU 316 stores the key information in the memory 306. As in the memory 208 in FIG. 2, a nonvolatile memory can be advantageously used for the memory 306. The memory 306 has a memory region for storing the Bluetooth device address of the lock device 14 to be unlocked by this key device 16, and another memory region for storing the PIN code shared by the lock device 14 and key device 16. A program stored in the memory 306 describes a procedure for performing the paging operation in response to the ‘on’ signal.

The paging operation (connecting operation) is controlled as follows. First, if the page button 18 is pressed when key device 16 and lock device 14 are within communication range of each other and the lock device 14 is operating in the Page_Scan mode, the key device 16 and lock device 14 exchange Bluetooth device address information. The key device 16 compares the Bluetooth device address of the lock device 14 with the Bluetooth device address stored in the memory 306, and transmits the PIN code stored in the memory 306 if the two addresses match, allowing the lock device 14 to authenticate the connection. If the connection is successfully authenticated, a piconet is formed in which, for example, the key device 16 functions as the master device and the lock device 14 functions as a slave device.

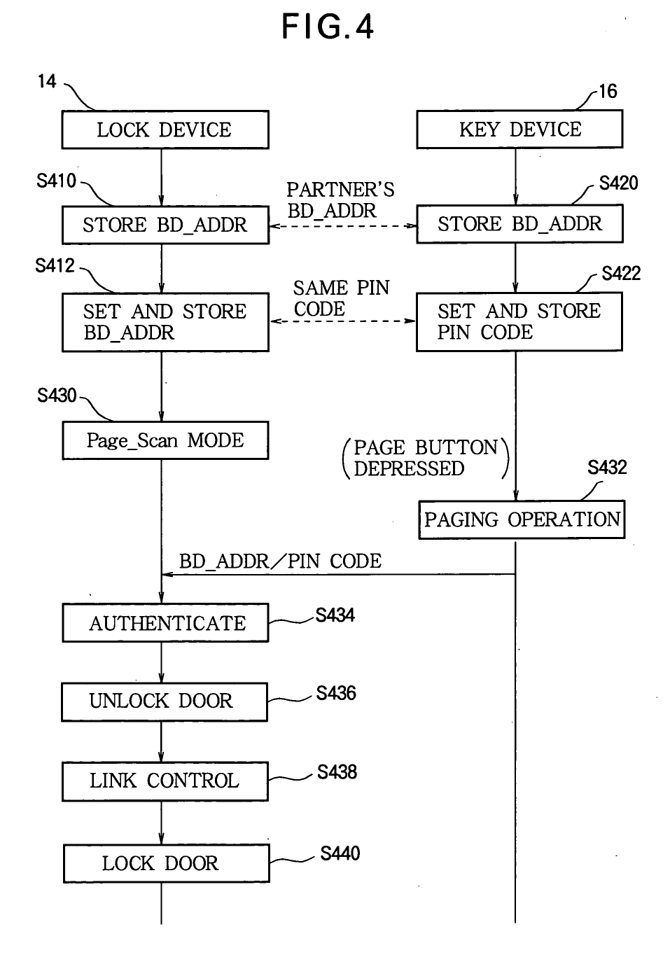

The operation of the key system 10 having the above-described configuration according to the present embodiment will be described with reference to the sequence diagram shown in FIG. 4. First, in steps S410 and S420, setup devices 20 are connected to the connectors 212 and 312 of the respective lock device 14 and key device 16 to perform initial settings. The setup devices 20 receive the Bluetooth device addresses (BD_ADDR) of the lock device 14 and key device 16 through respective cables 22 and 24. The setup devices 20 then perform a registering operation in which the Bluetooth device address of the lock device 14 is output to the key device 16 through the cable 24 and the Bluetooth device address of the key device 16 is output to the lock device 14 through the cable 22. The lock device 14 and key device 16 receive the Bluetooth device addresses sent from the setup devices 20 and store them in their respective memories 208 and 306. In the next steps S412 and S422, the setup devices 20 set the same PIN code in the lock device 14 and key device 16. The PIN code is stored in the memories 208 and 306 of the lock device 14 and key device 16 in addition to the other party's Bluetooth device address, which has been already stored.

After the initial setting has been completed as described above, the cables are disconnected to separate the setup devices 20 from the lock device 14 and key device 16, after which the lock device 14 and key device 16 start to operate wirelessly as a lock device and a key device, respectively.

In step S430, the lock device 14 is set to a Page_Scan mode in which the page scan is restricted to the Bluetooth device address of the paired device stored in the memory 208 of the lock device 14. In the Page_Scan mode, the lock device 14 functions as a slave device waiting for reception of information transmitted from the key device 16 that functions as the master device, while scanning signals transmitted from the master device at a specific paging scan rate.

In step S432, if the page button 18 of the key device 16 is pressed, the unique Bluetooth device address and PIN code are encrypted and transmitted from the key device 16 as key information. If the lock device 14 receives the key information, the lock device 14 decrypts the received Bluetooth device address to compare it with the address stored in the memory 208 in step S434. If the two addresses match, then the received and decrypted PIN code is compared with the PIN code stored in the memory 208. If this received key information matches the information stored in the memory 208, the connection is successfully authenticated and the sequence proceeds to step S436. If authentication of the connection fails, the lock device 14 maintains the Page_Scan mode.

In step S436, an unlock signal for releasing the lock is generated and output to the lock mechanism 206 to unlock the door. The lock mechanism 206 releases the lock of the door 12 for a predetermined number of seconds, during which the door 12 can be opened and closed. In the next step S438, the communication link between the lock device 14 and key device 16 is controlled; the link may be either maintained or disconnected in this step. Next, in step S440, the door 12 is automatically locked by the lock mechanism 206 a predetermined number of seconds after the door 12 has been opened and closed. As described above, the key information including the Bluetooth device address and PIN code is used for authenticating the connection to unlock the door.

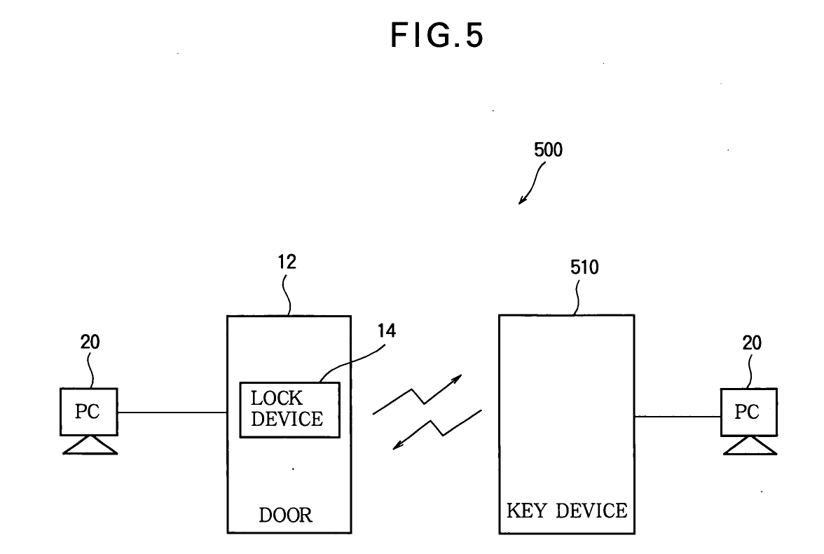

FIG. 5 illustrates a key system according to another embodiment of the invention. The key system 500 of this embodiment differs from the key system 10 in FIG. 1 in that the key device 510 does not have a page button 18 like the one provided in the key device 16; the door 12 can be unlocked without the press of a button. In other regards, key system 500 is substantially the same as key system 10.

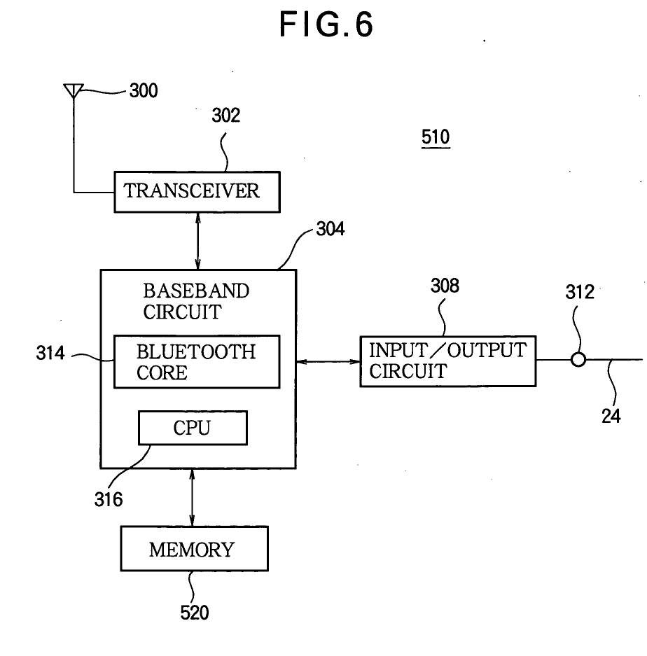

Referring to FIG. 6, like the key device 16 in FIG. 3, the key device 510 is a short-range wireless communication device comprising an antenna 300, a transceiver 302, a baseband circuit 304, and an input/output circuit 308. These constituent elements may be the same as the ones indicated by the same reference characters in FIG. 3. A memory 520 is connected to the baseband circuit 304. A nonvolatile memory similar to the memory 306 in FIG. 3 can advantageously be used for the memory 520. The memory 520 has a memory region for storing the Bluetooth device address of the lock device 14 to be paired with the key device 510 and another memory region for storing the PIN code shared by the two devices. In the present embodiment, the memory 520 also stores information describing a procedure for performing an auto paging operation, in which the CPU 316 automatically sets up a connection with the lock device 14. As the key device 510 is configured to carry out this auto paging operation, although the key device 510 lacks the page button 18 shown in FIG. 1, the paging operation is automatically started when the power of the key device 510 is turned on.

The lock device 14 installed in the door 12 maintains the communication link with the key device 510 even after unlocking the door, instead of returning to the Page_Scan mode. That is, the CPU 316 (FIG. 3) in the lock device 14 controls the communication link so that the communication link is maintained after the door 12 has been unlocked. This configuration prevents the unlocking operation from being repeated due to disconnection and reconnection of the link.

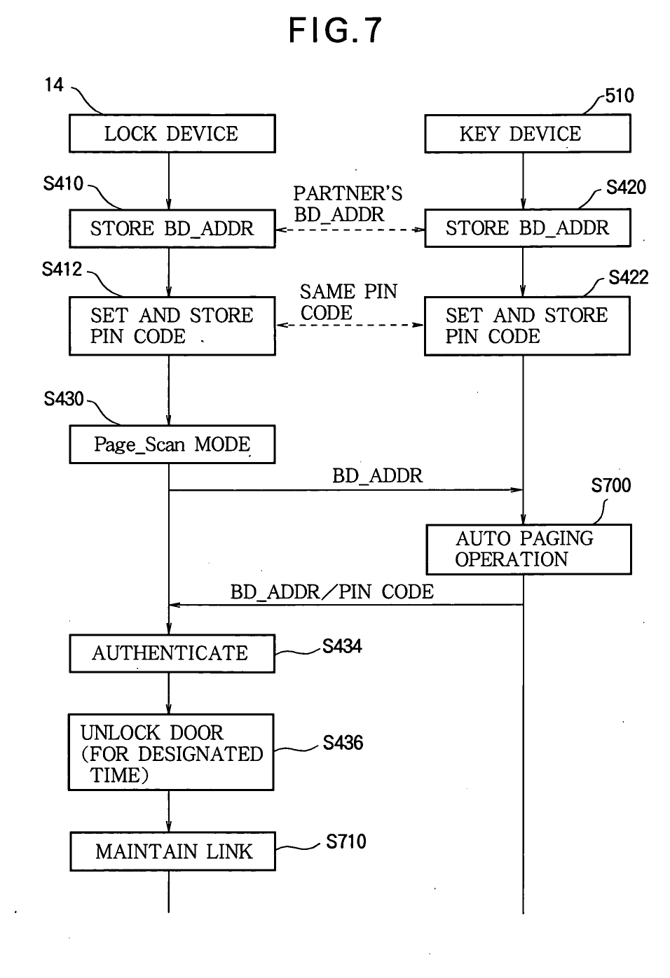

The operation of the key system 500 in the present embodiment will be described with reference to FIG. 7. Steps identical to steps in FIG. 4 are indicated by the same reference characters. These include steps S410 and S412, in which a Bluetooth device address and a PIN code are set and stored in the lock device 14 by a setup device 20, and steps S420 and S422, in which a Bluetooth device address and a PIN code are set and stored in the key device 510 by another setup device 20. After these initial settings have been completed, the setup devices 20 are disconnected from the lock device 14 and key device 510 to begin the normal operation of the key system.

The lock device 14 begins operation in a Page_Scan mode in step S430. The key device 510 begins auto paging in step S700.

In auto paging, the key device 510 periodically transmits a paging signal. When the key device 510 enters the communication area within which it can communicate normally with the lock device 14, the lock device 16 receives the paging signal, and the key device 510 and lock device 14 exchange Bluetooth device addresses. The key device 510 recognizes the Bluetooth device address transmitted from the lock device 14 and compares the received address with the Bluetooth device address stored in its memory 520. If the two addresses match, the key device 510 transmits the PIN code stored in the memory 520. The lock device 14 authenticates the connection by using the Bluetooth device address of the key device 510 and the PIN code. If the connection is successfully authenticated in step S434, a piconet is formed in which, for example, the key device 510 functions as the master device and the lock device 14 functions as a slave device.

If authentication of the connection succeeds, the sequence proceeds to step S436 and the Bluetooth core 214 (FIG. 2) in the lock device 14 outputs an unlock signal to the lock mechanism 206 (FIG. 2) to unlock the door 12. In the following step S710, the communication link between the lock device 14 and key device 510 is maintained.

As described above, the door 12 is unlocked whenever the user with the key device 510 approaches the door 12 and enters the area within which communication with the lock device 14 is possible. The communication link between the key device 510 and lock device 14 is then maintained after the user has entered the room, as long as the key device 510 remains within communication range of the lock device 14, thereby preventing the unlock operation from being repeated.

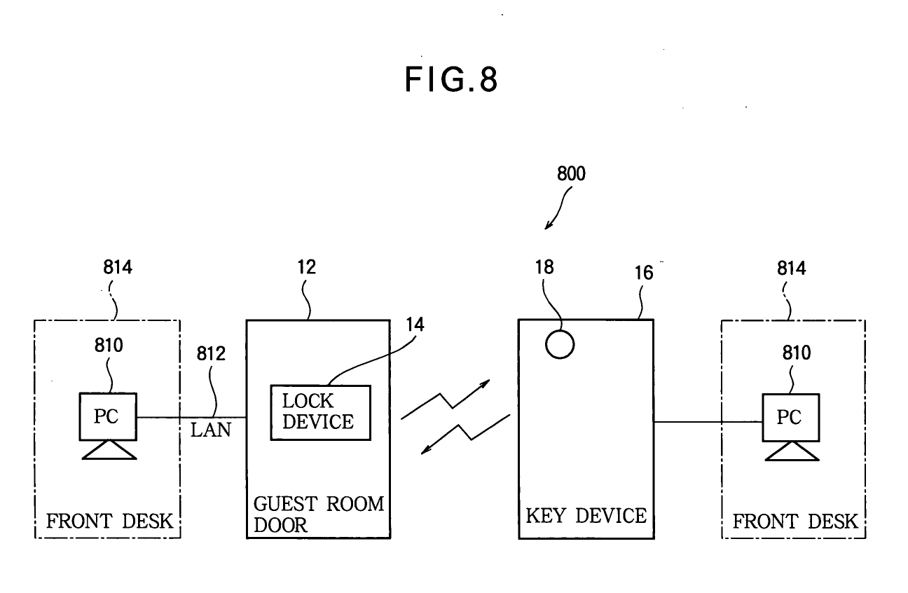

Both of the key systems 10 and 500 described above with reference to FIGS. 1 and 5 are applicable to the doors of the guest rooms in a hotel having a personal computer installed at its front desk. These systems can be used not only to unlock the doors of the guest rooms but also to monitor whether a room is occupied or not. An exemplary key system 800 is shown in FIG. 8. This key system 800 is similar to the key system 10 shown in FIG. 1, except that the lock device 14 and a computing device 810 are mutually connected by, for example, a LAN cable 812 and an interface (not shown). The computing device 810 is installed at a control facility such as the front desk 814 of a hotel.

The computing device 810 has the same function and configuration as the setup device 20 shown in FIG. 1, and additionally includes an administrative program for monitoring whether rooms are occupied or unoccupied.

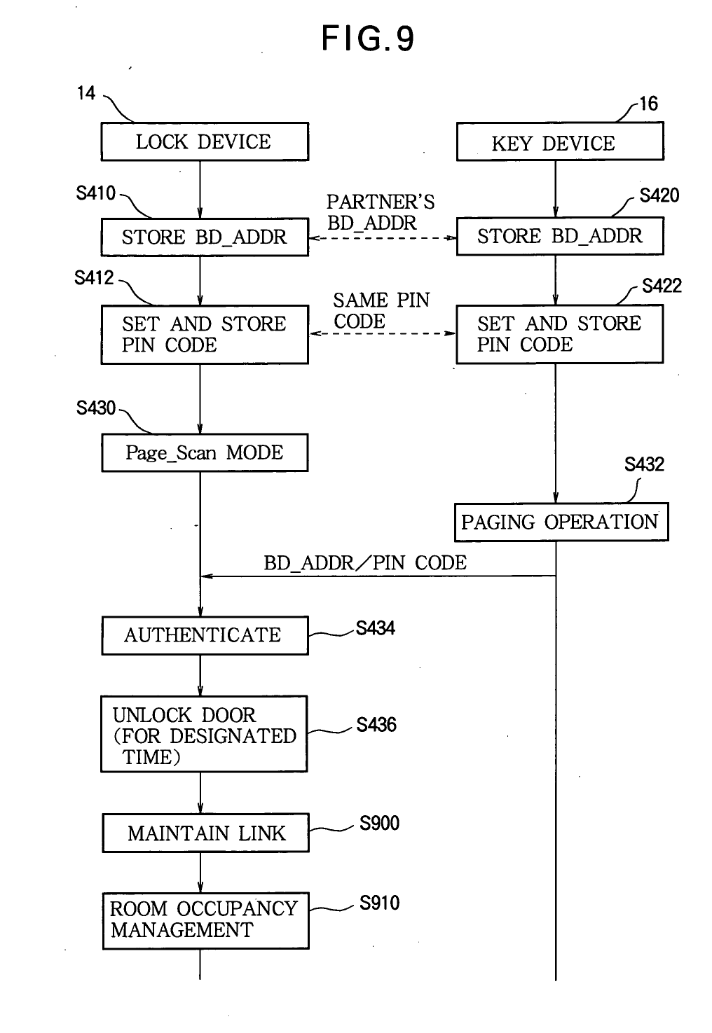

Referring to FIG. 9, the key system 800 may operate according to the same steps S410 to S436 as the key system 10, shown in FIG. 4. After the lock device 14 has been unlocked and the key device 16 has been brought into the guest room inside the door 12, the communication link between the lock device 14 and key device 16 is maintained as long as the key device 16 remains within the communication area (step S900) and the link status is reported to the computing device 810 by a status notification signal. By recognizing from the status notification signal that the link between the lock device 14 and key device 16 is being maintained, the computing device 810 recognizes that the room is occupied. The computing device 810 can thus tell whether a room is in use (step S910).

Key information can be set in the key device 16 by connecting the same or another computing device 810 to the key device 16 by a cable when a hotel guest checks in. Since key information can be set simultaneously in the lock device 14 at the front desk 814, a different PIN code can be stored in the lock device 14 and key device 16 for each room. This ensures that the same PIN code is shared only by the lock device 14 and key device 16 of a single room, and is not assigned to more than one hotel guest at a time.

The above description of the key system 800 has assumed the use of the key device 16 in key system 10, but other key devices may be employed. For example, the key device 510 in key system 500 can be used, allowing the system to operate in the auto paging mode without a page button.

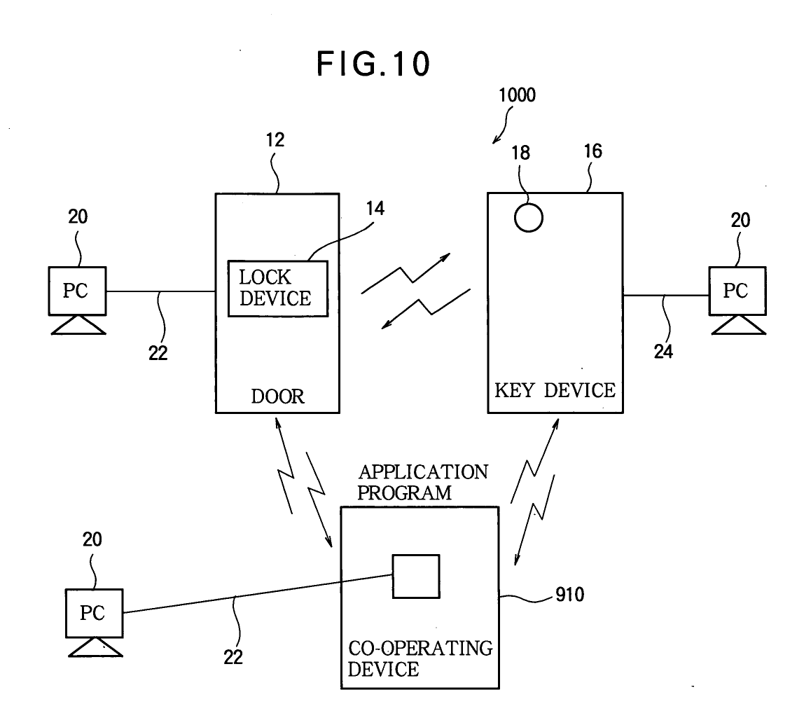

Another embodiment will now be described reference to FIG. 10. The key system 1000 in FIG. 10 has the same basic structure as in FIG. 1, but also includes a co-operating device 910 with a processor and memory in which an application program is installed. The key system 1000 is controlled in cooperation with the co-operating device 910.

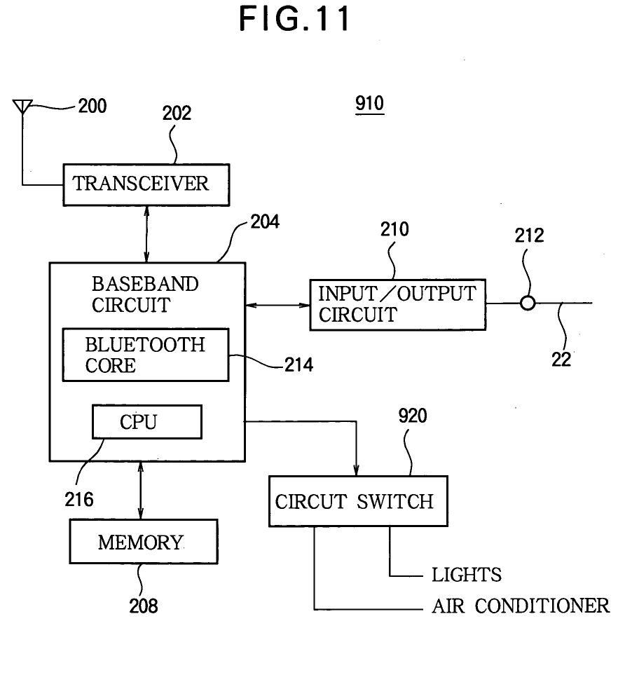

Referring to FIG. 11, the co-operating device 910 has substantially the same configuration as the lock device 14, but has a circuit switch 920 connected to the baseband circuit 204 in place of the lock mechanism 206 shown in FIG. 2. In response to control signals from the baseband circuit 204, the circuit switch 920 opens and closes a master power switch that supplies electricity for lighting, air conditioning, and other room facilities. The circuit switch 920 is controlled so the master power switch is on while the communication link between the lock device 14 and key device 16 is maintained, and is turned off when the lock device 14 and key device 16 are separated by more than a certain distance (the limiting Bluetooth wireless communication range) and the communication link is disconnected. In this embodiment, the lock device 14 transmits link connection information or link disconnection information to the co-operating device 910 according to the connection or disconnection of the communication link between the lock device 14 and key device 16 to control the co-operating device 910. Alternatively, the co-operating device 910 may switch power on and off according to the connection or disconnection status of its own communication link with the key device 16. Upon receiving link disconnection information, the co-operating device 910 stops the application program it has been running, or starts running another application program.

The lighting, air conditioning, and so on in the room are thus controlled so that they can be turned on only while the communication link between the key device 16 and the room door's lock device 14 (or co-operating device 910) is maintained. When the key device 16 is moved away from the room to a location outside the communication area and its communication link with the lock device 14 is disconnected, the door 12 is finally locked by the auto lock function, and at the same time, for example, the lighting, air conditioning, and so on in the room are automatically switched off by the application program.

The co-operating device 910 of the present embodiment may also be added to the key system 500 in FIG. 5. In an ordinary home, the co-operating device 910 may be used to control not only the supply of electricity, but also safety devices such as electromagnetic valves that shut off gas and water supplies in response to the disconnection of the communication link. As further safety measures, he co-operating device 910 may automatically lock windows and lock the door of a safe. A co-operating device 910 may also be built into electric equipment such as general home electric appliances to control them.

In this configuration, when the user enters the room, necessary operations are performed by the co-operating device 910, and when the user leaves the room, doors and windows are locked, appliances are turned off, and various safety measures are taken by the application program running on the co-operating device 910 without the user having to do any of these things or check that they have been done. Room safety is therefore maintained even if the user forgets to take safety precautions when leaving the room, and the user can be relieved from unnecessary anxiety when away from home.

If the key system of an automobile is configured so that the lock device 14 is installed in the door lock and the co-operating device 910 activates the ignition, the key system can not only unlock the door, but also start the engine.

The embodiments described above can be practiced in conjunction with other types of electronic technology. For example, the key device in the key systems described above can be built into a mobile telephone set, an electronic organizer, an electronic wristwatch, and other portable electronic devices. Alternatively, the key device may be formed as a small card, and may be used by insertion into the card slot of a portable information device such as, for example, a personal digital assistant (PDA).

The invention is not limited to short-range wireless communication conforming to the Bluetooth specification. Other types of short-range wireless communication in which each wireless communication terminal has a unique address may also be used.

Those skilled in the art will recognize that further variations are possible within the scope of the invention, which is defined in the appended claims.

1. A key system employing wireless communication to unlock a structure, the key system comprising:
a lock device for locking and unlocking the structure, the lock device including a first communication means for short-range wireless communication; and
a key device for including a second communication means for transmitting key information to the first communication means in the lock device by said short-range wireless communication;
wherein the lock device uses the key information received from the key device for authentication of a wireless communication link with the key device, and unlocks the structure if the authentication succeeds.

2. The key system of claim 1, wherein the first communication means has pre-assigned first unique information, the second communication means has pre-assigned second unique information, the first communication means stores the second unique information, the second communication means stores the first unique information, the second communication means transmits the second unique information to the first communication means as at least part of the key information, and the lock device uses the second unique information in authenticating the wireless communication link with the key device.

3. The key system of claim 2, wherein the lock device has a first memory for storing a shared code, the key device has a second memory for storing said shared code, the second communication means transmits the shared code to the first communication means as another part of the key information, and the lock device also uses the shared code in authenticating the wireless communication link with the key device.

4. The key system of claim 3, wherein the lock device has a first input means (210) for initial input of the key information and the lock device has a second input means (308) for initial input of the key information, the key information being supplied from a device (20) external to the key system.

5. The key system of claim 1, wherein the key device has a button for initiating wireless communication with the lock device.

6. The key system of claim 1, further comprising a computing device linked by a wired connection to the lock device, wherein after unlocking the structure, the lock device notifies the computing device, maintains the wireless communication link with the key device as long as the key device remains within wireless communication range of the lock device, and notifies the computing device again when the key device moves out of wireless communication range.

7. The key system of claim 6, wherein the structure is a door of a hotel room, and the computing device monitors room occupancy according to the notifications received from the lock device.

8. The key system of claim 1, further comprising an co-operating device having a third communication means for short-range wireless communication with the first communication means in the lock device, wherein after successful authentication of the connection with the key device, the lock device transmits control information to the co-operating device, and the co-operating device operates according to the control information received from the lock device.

9. The key system of claim 8, wherein the co-operating device also communicates with the key device by short-range wireless communication and operates according to information received from the key device.

10. The key system of claim 8, wherein the structure is a door of a hotel room, and the co-operating device operates a master power switch for the hotel room.

11. The key system of claim 8, wherein the structure is a house, and the co-operating device locks a window in the house.

12. The key system of claim 8, wherein the co-operating device operates an electrical appliance.

13. The key system of claim 8, wherein the co-operating device operates a gas valve.

14. The key system of claim 8, wherein the co-operating device operates a water valve.

15. The key system of claim 8, wherein the co-operating device locks a safe.

16. The key system of claim 8, wherein the structure is a door of an automobile having an engine and the co-operating device starts the engine.
